(19) United States
(12) Patent Application Publication
(10) Pub. No.: US 2009/0147318 A1
(43) Pub. Date: Jun. 11, 2009

(54) Scanning device having positioning element for adjusting scanning area

(75) Inventor: Po-Yuan Chang, Tainan City (TW)

Correspondence Address: BACON & THOMAS, PLLC, 625 SLATERS LANE, FOURTH FLOOR, ALEXANDRIA, VA, 22314-1176, US

(73) Assignee: AVISION INC., Hsinchu (TW)

(21) Appl. No.: 12/285,591

(22) Filed: Oct. 9, 2008

(30) Foreign Application Priority Data
Dec. 6, 2007 (TW) 96146607

(51) Int. Cl. H04N 1/04

(52) U.S. Cl. 358/474

(57) ABSTRACT

A scanning device includes a housing, an optical module and a positioning element. The optical module is movably disposed in the housing. The positioning element disposed on the housing is movable in a direction substantially parallel to a moving path of the optical module so as to adjust the range of a scanning area. When a to-be-scanned document is scanned, the optical module moves inside the scanning area for performing scanning.

This application claims the benefit of Taiwan application Serial No. 96146607, filed Dec. 6, 2007, the subject matter of which is incorporated herein by reference.

### BACKGROUND OF THE INVENTION

1. Field of the Invention

The invention relates in general to a scanning device, and more particularly to a scanning device having a positioning element for adjusting the range of the scanning area.

2. Description of the Related Art

With the advance in image scanning technology and the improvement in the optical characteristics of the scanners, the application of the scanners has become comprehensive. In addition to scanning ordinary photos and documents, scanners are also capable of scanning high-resolution photos or negative films used in medical purpose or large-scale engineering projects. Scanners can acquire and convert the document images into digital image data and directly store the digital image data in a computer for the purposes of reducing the space for the storage of the hardcopies of the photos and documents and of extending the preservation the photos and documents. Besides, image processing techniques such as reduction/enlargement, color enhancement or special effect can be applied to the digital image data which have been outputted to the computer. The image scanning technology makes the application of the images more flexible and makes people's life more interesting.

An ordinary flatbed scanner has a fixed scanning starting position and a fixed scanning ending position, wherein the scanning starting position and the scanning ending position, for example, are respectively located at two ends of a platform used for carrying a to-be-scanned document. When scanning an object such as a book or a document, the optical module moves from the scanning starting position to the scanning ending position in a forward direction to perform the scanning procedure. When the optical module reaches the scanning ending position, the optical module stops moving and finishes scanning the object. Next, the optical module moves in a direction opposite to the forward direction to return to the scanning starting position and to prepare for the next scan.

Regardless of the size of the to-be-scanned object, the optical module moves between the scanning starting position and the scanning ending position. When the size of the object is smaller or shorter than the distance between the scanning starting position and the scanning ending position, the optical module wastes a lot of time for moving through an area containing no scanning object. Particularly, when scanning a page in the course of scanning a book or a copy of multi-page document, the optical module repeatedly moves to the scanning ending position from the scanning starting position and then returns back to the scanning starting position immediately. Thus, during the scanning procedure, a large amount of time is wasted in moving the optical module.

The currently available methods are done by increasing the moving speed of the optical module so as to increase the efficiency of the scanners. However, the driving mechanism of the scanner must be replaced or the driving circuit must be re-designed to accommodate such improvement, thus largely increasing the cost. Moreover, a fast scanning speed would deteriorate scanning quality, increase power consumption or increase the damage rate of the components of the scanners.

### SUMMARY OF THE INVENTION

The invention is directed to a scanning device having a positioning element for adjusting a scanning area. The range of the scanning area is adjusted by at least one positioning element such that the optical module does not need to move along the platen of the scanning device to the full length at each scanning, hence increasing the efficiency in scanning a document.

According to a first aspect of the present invention, a scanning device including a housing, an optical module and a positioning element is provided. The optical module is movably disposed in the housing. The positioning element disposed on the housing is movable in a direction substantially parallel to a moving path of the optical module so as to adjust the range of a scanning area. The optical module moves inside the scanning area to scan a to-be-scanned document.

The invention will become apparent from the following detailed description of the preferred but non-limiting embodiments. The following description is made with reference to the accompanying drawings.

### BRIEF DESCRIPTION OF THE DRAWINGS

FIG. 1 shows a perspective view of a scanning device according to a first embodiment of the invention;

FIG. 2 shows a moving path of an optical module in FIG. 1;

FIG. 3 shows a partial cross-sectional view of the scanning device in FIG. 1 when the optical module is located at a first boundary position;

FIG. 4 shows a perspective view of a scanning device according to a second embodiment of the invention; and

FIG. 5 shows a moving path of an optical module in FIG. 4.

### DETAILED DESCRIPTION OF THE INVENTION

According to the scanning device disclosed in a preferred embodiment of the invention, at least one positioning element is used to adjust the range of a scanning area such that the range of the scanning area corresponds to the length of a to-be-scanned document. When the to-be-scanned document is scanned, the optical module moves inside the scanning area. After finishing scanning the to-be-scanned document, the optical module stops at a boundary of the scanning area. The invention is exemplified below by a first and a second embodiment. However, these embodiments are for exemplification only not for limiting the scope of protection of the invention. Also, secondary elements are omitted in the embodiments of the invention to highlight the technical features of the invention.

### First Embodiment

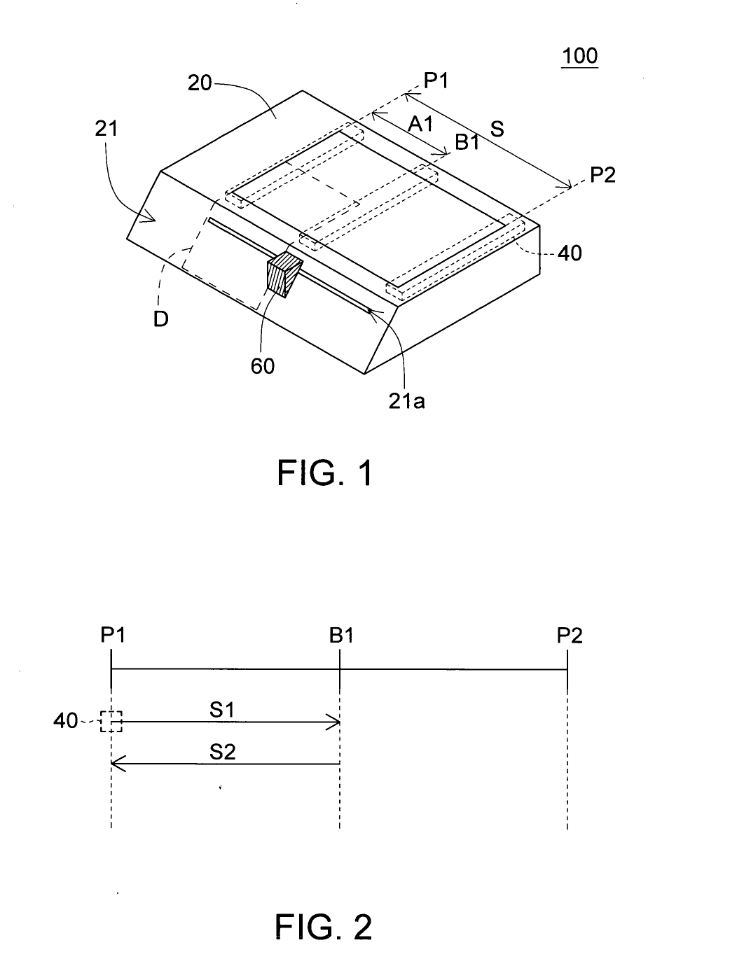

Referring to FIG. 1, a perspective view of a scanning device according to a first embodiment of the invention is shown. The scanning device 100 includes a housing 20, an optical module 40 and a positioning element 60. The optical module 40 is moveably disposed in the housing 20. The positioning element 60 is disposed on the housing 20 and is movable in a direction substantially parallel to a moving path S of the optical module 40 so as to adjust the range of a scanning area A1. When scanning a to-be-scanned document D, the optical module 40 moves inside the scanning area A1 for performing scanning.

Furthermore, a first position P1 and a second position P2 define two ends of the moving path S of the optical module 40. The positioning element 60 is located and movable between the first position P1 and the second position P2. Moreover, the position of the positioning element 60 defines a first boundary position B1 of the scanning area A1, and the range of the scanning area A1 is defined by the first boundary position B1 and first position P1. After the optical module 40 moves towards the second position P2 and finishes scanning the first page of the to-be-scanned document D corresponding to the scanning area A1, the optical module 40 stops at the first boundary position B1. After the optical module 40 moves towards the first position P1 and finishes scanning another page of the to-be-scanned document D corresponding to the scanning area A1, the optical module 40 stops at the first position P1. The movement of the optical module 40 is disclosed below.

Referring to FIG. 2, a moving path of an optical module of FIG. 1 is shown. In the exemplification of the present embodiment of the invention, the to-be-scanned document D contains multiple pages, and the starting position of the optical module 40 is the first position P1 for example. When scanning the first page of the to-be-scanned document D, the optical module 40 moves towards the second position P2 from the first position P1 to perform the scanning procedure. After finishing scanning the first page of the to-be-scanned document D corresponding to the scanning area A1, the optical module 40 stops at the first boundary position B1 as indicated in the first path S1.

Next, when scanning the second page of the to-be-scanned document D, the optical module 40 moves towards the first position P1 from the first boundary position B1 to perform the scanning procedure. After finishing scanning the second page of the to-be-scanned document D corresponding to the scanning area A1, the optical module 40 stops at the first position P1 as indicated in the second path S2. When the scanning device 100 scans the third page, the fourth page or more pages, the optical module 40 only needs to move along the first path S1 and the second path S2. That is, when scanning a multi-pages to-be-scanned document D, the optical module 40 only needs to move reciprocally between the first position P1 and the first boundary position B1, hence largely shortening the moving path of the optical module 40 and increasing the efficiency in document scanning.

The first position P1 is used as the starting position for the moving path of the optical module 40. However, the second position P2 can also be used as the starting position. When the optical module 40 moves towards the first position P1 from the second position P2 and passes through the first boundary position B1, the optical module 40 starts scanning and stops at the first position P1 after finishing scanning.

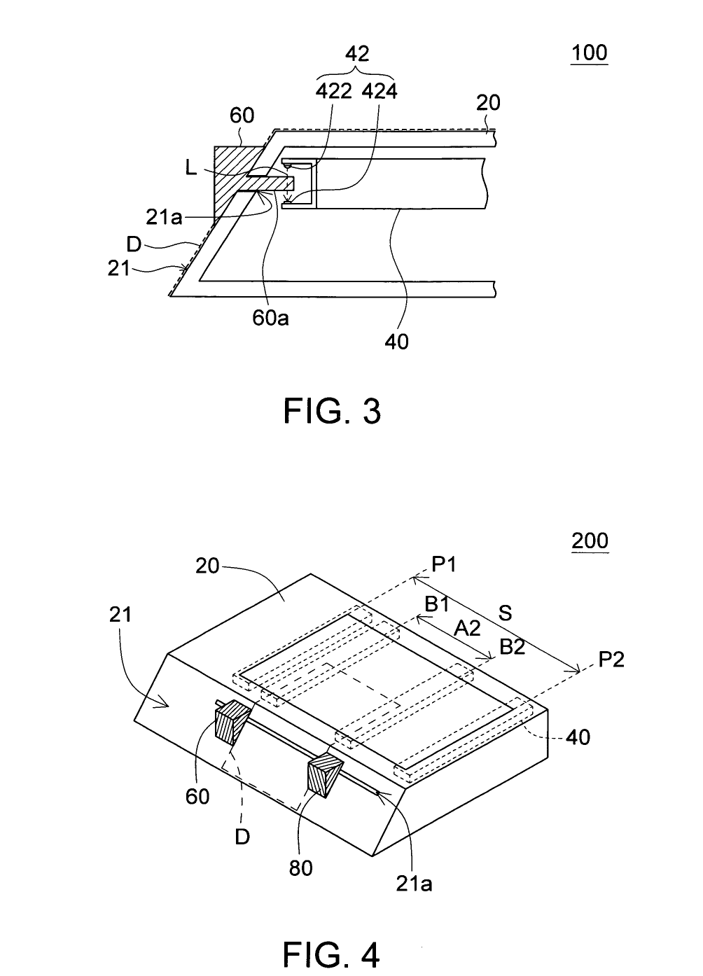

On the other hand, the setting of the range of the first boundary position B1 is disclosed below and illustrated by FIG. 3. FIG. 3 shows a partial cross-sectional view of the scanning device 100 in FIG. 1 when the optical module 40 is located at a first boundary position B1. The optical module 40 further includes a sensing element 42 used for detecting the position of the positioning element 60. In the present embodiment of the invention, the sensing element 42, for example, includes a light emitter 422 and a light sensor 424. The light emitter 422 emits a light signal, such as an infrared light L, towards the light sensor 424. The positioning element 60, for example, has a flange 60a projected toward the inner side of the housing 20. When the optical module 40 moves towards the second position P2 along the first path S1 (illustrated in FIG. 2) and has moved to the side of the positioning element 60, the flange 60a blocks the infrared light L. Meanwhile, the light sensor 424 cannot receive the infrared light L, and the optical module 40 outputs a sensing signal stops scanning according to the sensing element 42. By doing so, the scanning device 100 of the present embodiment of the invention defines the position of the positioning element 60 as the first boundary position B1 of the scanning area A1.

Moreover, when the optical module 40 moves towards the first position P1 from the second position P2 and has moved to the side of the positioning element 60, the flange 60a blocks the infrared light L. Meanwhile, the light sensor 424 cannot receive the infrared light L, the optical module 40 starts scanning according to the sensing signal outputted from the sensing element 42.

In the above method of defining the first boundary position B1, the infrared light L emitted from the light emitter 422 is blocked by the flange 60a of the positioning element 60. In other implementations, the sensing element 42 can be disposed on the positioning element 60 and further combined with the optical module 40 having a flange to perform detecting. However, the technology of the invention is not limited to the above implementations, and other implementations capable of detecting the positioning element 60 by ways of using magnetic induction or a switch mechanism or by determining electrical conduction are all applicable to the scanning device 100.

In the present embodiment of the invention, as indicated in FIG. 1, the scanning device 100, for example, is a book scanner; the housing 20 has an inclined lateral side 21; the to-be-scanned document D, is a bound document such as a book. The positioning element 60 is moveably disposed on the lateral side 21. The positioning element 60 is movable along a slot 21a disposed on the lateral side 21 and the flange 60a projects through the slot 21 toward the inner side of the housing 20. The user can adjust the position of the positioning element 60 so as to set the range of the scanning area A1. When scanning the to-be-scanned document D, the positioning element 60 preferably presses against a side of the to-be-scanned document D, such that the length of the scanning area A1 is substantially equal to that of the to-be-scanned document D and the to-be-scanned document D will not slide. The side of the to-be-scanned document D which the positioning element 60 presses against is substantially perpendicular to the moving path of the optical module

The scanning device 100 according to the first embodiment of the invention scans the to-be-scanned document D by using the positioning element 60 to adjust the range of the scanning area A1 and moving an optical module 40 reciprocally between the first position P1 and the first boundary position B1. As the optical module 40 only needs to move within the scanning area A1 during the scanning procedure, the optical module 40 largely reduces the distance and the time of movement so as to increase the efficiency of the scanners.

### Second Embodiment

The scanning device of the present embodiment of the invention differs with the scanning device of the first embodiment mainly in the quantity of the positioning elements. As for other similarities, the same designations are used and are not repeated here.

Referring to FIG. 4, a perspective view of a scanning device according to a second embodiment of the invention is shown. The scanning device 200 further includes another positioning element 80 in addition to a housing 20, an optical module 40 and a positioning element 60 as disclosed in the first embodiment. The another positioning element 80 is disposed on the housing 20 and is movable in a direction substantially parallel to the moving path S of the optical module 40. The another positioning element 80 and the positioning element 60 are used to adjust the range of a scanning area A2. In the present embodiment of the invention, positions of the positioning element 60 and the another positioning element 80 define the first position P1 and the second position P2. The positions of the positioning element 60 and the another positioning element 80 respectively define a first boundary position B1 and a second boundary position B2 of the scanning area A2. In other words, the range of the scanning area A2 is defined by the first boundary position B1 and the second boundary position B2.

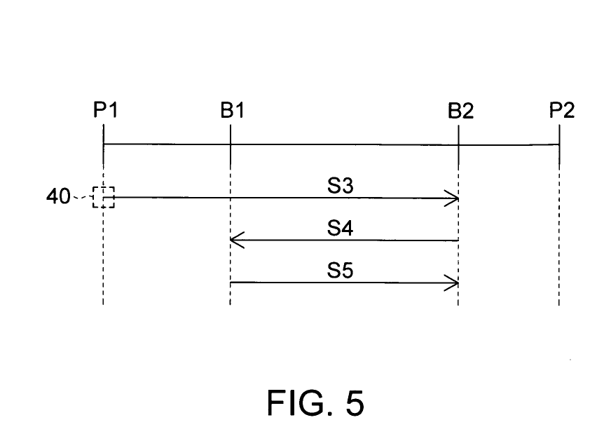

Referring to FIG. 5, a moving path of an optical module in FIG. 4 is shown. In the following exemplification, the first position P1 is used as the starting position for the moving path of the optical module 40. When scanning the first page of the to-be-scanned document D, the optical module 40 moves towards the second position P2 from the first position P1. After finishing scanning the first page of the to-be-scanned document D corresponding to the scanning area A2, the optical module 40 stops at the second boundary position B2 as indicated in a third path S3. Next, when scanning the second page of the to-be-scanned document D, the optical module 40 moves towards the first position P1 from the second boundary position B2 to perform the scanning procedure. After finishing scanning the second page of the to-be-scanned document D corresponding to the scanning area A2, the optical module 40 stops at the first boundary position B1 as indicated in a fourth path S4. Afterwards, when scanning the third page of the to-be-scanned document D, the optical module 40 moves towards the second position P2 from the first boundary position B1 to perform the scanning procedure. After finishing scanning the third page of the to-be-scanned document D corresponding to the scanning area A2, the optical module 40 stops at the second boundary position B2 as indicated in a fifth path S5.

Then, when the scanning device 200 scans the fourth page, the fifth page, or more pages, the optical module 40 only needs to repeatedly move along the fourth path S4 and the fifth path S5. That is, when scanning a multi-pages to-be-scanned document D, the optical module 40 only needs to move reciprocally between the first boundary position B1 and the second boundary position B2, hence largely shortening the moving path of the optical module 40 and increasing the efficiency in document scanning.

The scanning device 200 of the present embodiment of the invention can use a sensing element (not illustrated in the diagram) of the optical module 40 to detect the positions of the positioning element 60 and the another positioning element 80 so as to define the first boundary position B1 and the second boundary position B2. Moreover, the optical module 40 starts or stops scanning according to the sensing signal outputted by the sensing element.

In the present embodiment of the invention, the positioning element 60 and the another positioning element 80 can respectively be movably disposed on one lateral side 21 of the housing 20. The positioning element 60 and another positioning element 80 are respectively disposed on the lateral side 21 via a slot 21a for example. When scanning the to-be-scanned document D, the positioning element 60 and the another positioning element 80 respectively press two opposite sides of the to-be-scanned document D, such that the length of the scanning area A2 is substantially equal to that of the to-be-scanned document D.

The scanning device disclosed in the preferred embodiments of the invention uses at least one positioning element to adjust the range of a scanning area. When scanning a multi-page or bound document, the optical module only needs to move reciprocally within the range of the scanning area, so that the distance of repeated movement of the optical module when scanning a multi-page document is largely reduced. Thus, the efficiency of the scanners is increased without replacing the driving mechanism of the optical module to increase the moving speed of the optical module.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scanning device, comprising:
a housing;
an optical module movably disposed in the housing; and
a positioning element disposed on the housing, wherein the positioning element is movable in a direction substantially parallel to a moving path of the optical module so as to adjust a range of a scanning area;
wherein the optical module moves inside the scanning area to scan a to-be-scanned document.

2. The scanning device according to claim 1, wherein a first position and a second position define two ends of the moving path, the positioning element is located between the first position and the second position, and a position of the positioning element define a first boundary position of the scanning area.

3. The scanning device according to claim 2, wherein the range of the scanning area is defined by the first position and the first boundary position.

4. The scanning device according to claim 2, wherein after the optical module moves towards the second position and finishes scanning the to-be-scanned document inside the scanning area, the optical module stops at the first boundary position.

5. The scanning device according to claim 1, wherein the positioning element is movably disposed on one lateral side of the housing.

6. The scanning device according to claim 5, wherein the to-be-scanned document is a bound document, and when the to-be-scanned document is scanned, the positioning element presses against a side of the to-be-scanned document, wherein the side of the to-be-scanned document is substantially perpendicular to the moving path of the optical module.

7. The scanning device according to claim 1, wherein the optical module comprises:
a sensing element used for detecting a position of the positioning element and outputting a sensing signal.

8. The scanning device according to claim 7, wherein the optical module starts or stops scanning according to the sensing signal.

9. The scanning device according to claim 1, wherein the scanning device further comprises:
an another positioning element disposed on the housing, wherein the another positioning element is movable in a direction substantially parallel to a moving path of the moving path so as to adjust the range of the scanning area.

10. The scanning device according to claim 9, wherein a first position and a second position define two ends of the moving path, the positioning element and the another positioning element are located between the first position and the second position, the another positioning element is located between the second position and the positioning element, the positions of the positioning element and the another positioning element respectively define a first boundary position of and a second boundary position of the scanning area.

11. The scanning device according to claim 10, wherein the range of the scanning area is defined by the first boundary position and the second boundary position.

12. The scanning device according to claim 10, wherein after the optical module moves towards the second position and finishes scanning the to-be-scanned document inside the scanning area, the optical module stops at the second boundary position.

13. The scanning device according to claim 10, wherein after the optical module moves towards the first position and finishes scanning the to-be-scanned document inside the scanning area, the optical module stops at the first boundary position.

14. The scanning device according to claim 9, wherein the positioning element and the another positioning element are movably disposed on one lateral side of the housing.

15. The scanning device according to claim 14, wherein the to-be-scanned document is a bound document, and when the to-be-scanned document is scanned, the positioning element and the another positioning element respectively press two opposite sides of the to-be-scanned document, wherein the two opposite sides of the to-be-scanned document are substantially perpendicular to the moving path of the optical module.

16. The scanning device according to claim 9, wherein the optical module comprises:
a sensing element used for detecting positions of the positioning element and the another positioning element and outputting a sensing signal.

17. The scanning device according to claim 16, wherein the optical module starts or stops scanning according to the sensing signal.
